(19) United States
(12) Patent Application Publication
(10) Pub. No.: US 2012/0197617 A1
(43) Pub. Date: Aug. 2, 2012

(54) Co-Simulation with Peer Negotiated Time Steps

(76) Inventors: Muris Mujagic, Toronto (CA); Damon M. Bohls, Austin, TX (US)

(21) Appl. No.: 13/347,880

(22) Filed: Jan. 11, 2012

Related U.S. Application Data
(60) Provisional application No. 61/437,928, filed on Jan. 31, 2011.

(51) Int. Cl. G06G 7/48

(52) U.S. Cl. 703/7; 703/6

(57) ABSTRACT

System and method for co-simulation. A first simulator and a second simulator are included in a co-simulation program. The co-simulation program is executed, including executing the first simulator and the second simulator. During execution, the first simulator receives input from the second simulator and provides output to the second simulator, and the second simulator receives input from the first simulator and provides output to the first simulator. Executing the co-simulation program includes the first simulator and the second simulator negotiating step-size as peers to dynamically synchronize the first simulator and the second simulator.

### PRIORITY DATA

This application claims benefit of priority to U.S. Provisional application Ser. No. 61/437,928, titled “Co-Simulation with Peer Negotiated Time Steps”, filed Jan. 31, 2011, whose inventors were Muris Mujagic and Damon M. Bohls.

### FIELD OF THE INVENTION

The present invention relates to the field of co-simulation, and more particularly to a system and method for peer negotiation of simulation step size by simulators in a co-simulation to dynamically synchronize the simulations.

### DESCRIPTION OF THE RELATED ART

Co-simulation refers to a simulation that includes multiple simulators (also referred to as simulation programs) executing respective simulations (or sub-simulations) in tandem to collectively simulate a larger system. Said another way, co-simulation is a simulation methodology wherein different parts of a system are simulated by different (e.g., specialized) simulation tools running concurrently and communicating with each other. In many cases the simulators in a co-simulation (i.e., a co-simulation program) may have different step sizes, e.g., time increments, which may make synchronization of the simulators (and thus, their respective simulations) more difficult.

In one prior art approach to synchronizing such simulators in a co-simulation, a supervisory process determines the step size for each of the simulators. However, this technique introduces complications in that the supervisory process must be designed and maintained, and may be dependent upon the particular attributes of the simulators. For example, the supervisory process may be specific, i.e., custom designed, to the simulators involved.

In yet another prior art approach, one of the simulators may be designated as primary, and may impose its step size on the other simulator(s). However, the specified prioritization may not always be suitable for the simulators involved. In other words, the specified prioritization may be incorrect from the start, or the appropriate prioritization may change over the course of execution of the co-simulation.

Thus, improved systems and methods for synchronizing simulators in a co-simulation are desired.

### SUMMARY OF THE INVENTION

Various embodiments of a system and method for synchronizing simulators in a co-simulation are presented below.

A first simulator and a second simulator may be included in a co-simulation program. The first and second simulators may be developed under, and/or execute under, different development and/or execution environments, referred to herein as first and second environments, respectively. For example, in one exemplary embodiment, the first simulator may be a LabVIEW simulator, e.g., developed and/or executed under the LabVIEW graphical program development environment, and the second simulator may be a Multisim simulator, e.g., a simulator that executes a circuit simulation developed and/or executed under the Multisim development environment.

The co-simulation program may be executed. Executing the co-simulation program may include executing the first simulator and the second simulator, where during execution, the first simulator receives input from the second simulator and provides output to the second simulator, and the second simulator receives input from the first simulator and provides output to the first simulator. Executing the co-simulation program may further include the first simulator and the second simulator negotiating step size as peers to dynamically synchronize the first simulator and the second simulator.

In other words, the first and second simulators may negotiate with each other as peers to determine a step size that is acceptable to both programs. Moreover, this negotiation may occur repeatedly as the co-simulation executes, thereby keeping the two simulators synchronized. Note that the determined step size may change over the course of execution of the co-simulation program. For example, in one embodiment, the step size may be negotiated (determined) for each cycle (step) of the co-simulation.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system configured to implement an embodiment of the present invention;

FIG. 1B illustrates a network system comprising a computer system and an embedded device that may implement an embodiment of the present invention;

FIG. 2A illustrates an exemplary co-simulation diagram with a LabVIEW simulator/simulation and a Multisim simulator/simulation, according to one embodiment;

FIG. 2B illustrates an exemplary co-simulation diagram with a LabVIEW simulator/simulation and multiple Multisim simulators/simulations, according to one embodiment;

FIG. 3A is a high level flowchart diagram illustrating one embodiment of a method for synchronizing simulators in a co-simulation;

FIG. 3B is a mid-level flowchart diagram illustrating peer negotiation of step size between two simulators in a co-simulation program, according to one embodiment;

FIG. 4 is a detailed flowchart diagram illustrating peer negotiation of step size between two simulators in a co-simulation program, according to one embodiment;

FIGS. 5A and 5B illustrate co-simulation time steps with and without enablement of an “is first sim time minor step?” determination option, according to one embodiment of the invention;

FIGS. 6A and 6B illustrate a blank first simulator with blank front panel, according to one embodiment of the invention;

FIG. 7 illustrates the first (LabVIEW) simulator with a simulation loop, according to one embodiment;

FIG. 8 illustrates a second (Multisim) simulator, according to one embodiment of the invention;

FIG. 9 illustrates selection of a Multisim block from a palette, according to one embodiment;

FIG. 10 illustrates designation of a circuit simulation file for the Multisim block of FIG. 9, according to one embodiment;

FIG. 11 illustrates placement of the Multisim block into the simulation loop of the first (LabVIEW) simulator, according to one embodiment;

FIG. 12A illustrates the completed co-simulation program, including the first (LabVIEW) simulator with the second (Multisim) simulator contained within, according to one embodiment;

FIG. 12B illustrates the completed front panel for the co-simulation program of FIG. 12A, according to one embodiment;

FIG. 13 illustrates I/O connections for the second (Multisim) simulator block, according to one embodiment;

FIG. 14 is a flowchart of an exemplary method for communications between simulators, according to one embodiment;

FIGS. 15A-15C illustrate exemplary interface architectures for co-simulation communications; and

FIGS. 16-19 illustrate the use of various solvers that utilize minor time steps, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:
U.S. Provisional application Ser. No. 61/437,928, titled “Co-Simulation with Peer Negotiated Time Steps”, filed Jan. 31, 2011.
U.S. Pat. No. 4,914,568 titled “Graphical System for Modeling a Process and Associated Method,” issued on Apr. 3, 1990.
U.S. Pat. No. 5,481,741 titled “Method and Apparatus for Providing Attribute Nodes in a Graphical Data Flow Environment”.
U.S. Pat. No. 6,173,438 titled “Embedded Graphical Programming System” filed Aug. 18, 1997.
U.S. Pat. No. 6,219,628 titled “System and Method for Configuring an Instrument to Perform Measurement Functions Utilizing Conversion of Graphical Programs into Hardware Implementations,” filed Aug. 18, 1997.
U.S. Pat. No. 7,210,117 titled “System and Method for Programmatically Generating a Graphical Program in Response to Program Information,” filed Dec. 20, 2000.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning The term “program” includes 1) a software program which may be stored in a memory and is executable by a processor or 2) a hardware configuration program useable for configuring a programmable hardware element.

Graphical Program—A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include LabVIEW®, Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program—A Software Program in which the program architecture is that of a directed graph specifying the flow of data through the program, and thus functions execute whenever the necessary input data are available. Data flow programs can be contrasted with procedural programs, which specify an execution flow of computations to be performed. As used herein “data flow” or “data flow programs” refer to “dynamically-scheduled data flow” and/or “statically-defined data flow”.

Graphical Data Flow Program (or Graphical Data Flow Diagram)—A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW VI is one example of a graphical data flow program. A Simulink block diagram is another example of a graphical data flow program.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

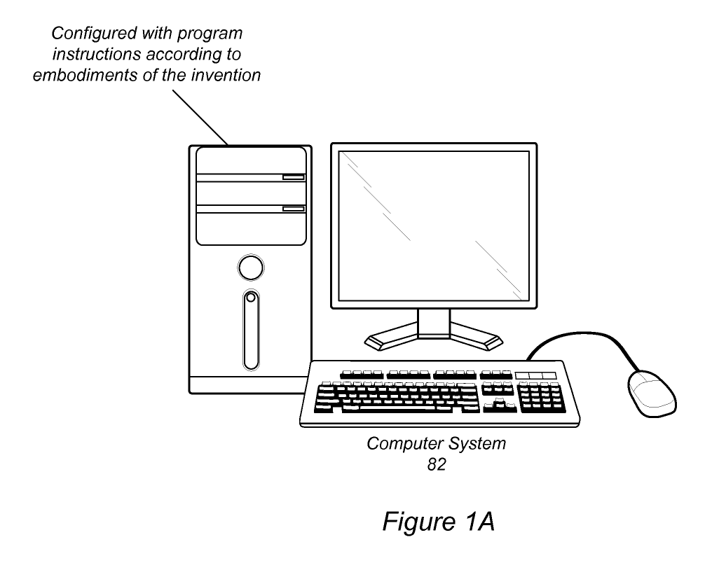

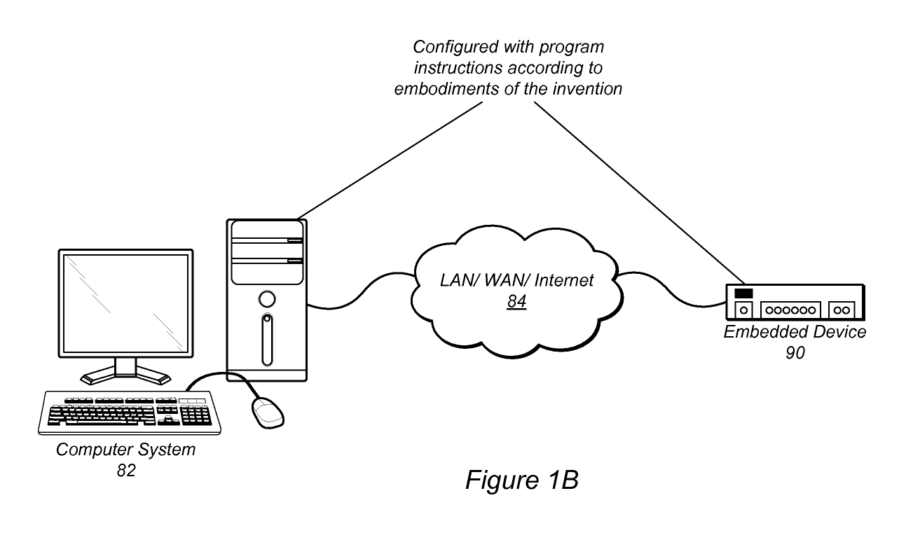

### FIG. 1A—Computer System

FIG. 1A illustrates a computer system 82 configured with program instructions implementing one embodiment of a method for synchronizing simulators in a co-simulation.

As shown in FIG. 1A, the computer system 82 may include a display device configured to display the co-simulation as the co-simulation is created and/or executed. The display device may also be configured to display a graphical user interface or front panel of the co-simulation during execution of the graphical program. The graphical user interface (GUI) may comprise any type of graphical user interface, e.g., depending on the computing platform. The display device may also be configured to display a GUI of a program development environment and/or an execution environment, under which the co-simulation or individual simulator/simulations may be developed or executed.

The computer system 82 may include at least one memory medium on which one or more computer programs or software components according to embodiments of the present invention may be stored. For example, the memory medium may store program instructions which are executable to perform embodiments of the methods described herein. Additionally, the memory medium may store a programming development environment application used to create or execute simulators or co-simulations. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system, specifically, an embedded device 90, although any other type of computer system may be used as desired. The computer system 82 may be coupled via a network 84 (or a computer bus) to the embedded device 90. The computer systems 82 and 90 may each be any of various types, as desired. The network 84 can also be any of various types, including a LAN (local area network), WAN (wide area network), the Internet, or an Intranet, among others. The computer systems 82 and 90 may execute the co-simulation in a distributed fashion. For example, computer 82 may execute a first simulator of the co-simulation and the second computer system 90 may execute a second simulator of the co-simulation. As another example, computer 82 may display a graphical user interface of the co-simulation and computer system 90 may execute the first and second simulators of the co-simulation.

In some embodiments, the embedded device 90 may include a programmable hardware element and/or may include a processor and memory medium, which, in one embodiment, may execute a real time operating system.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

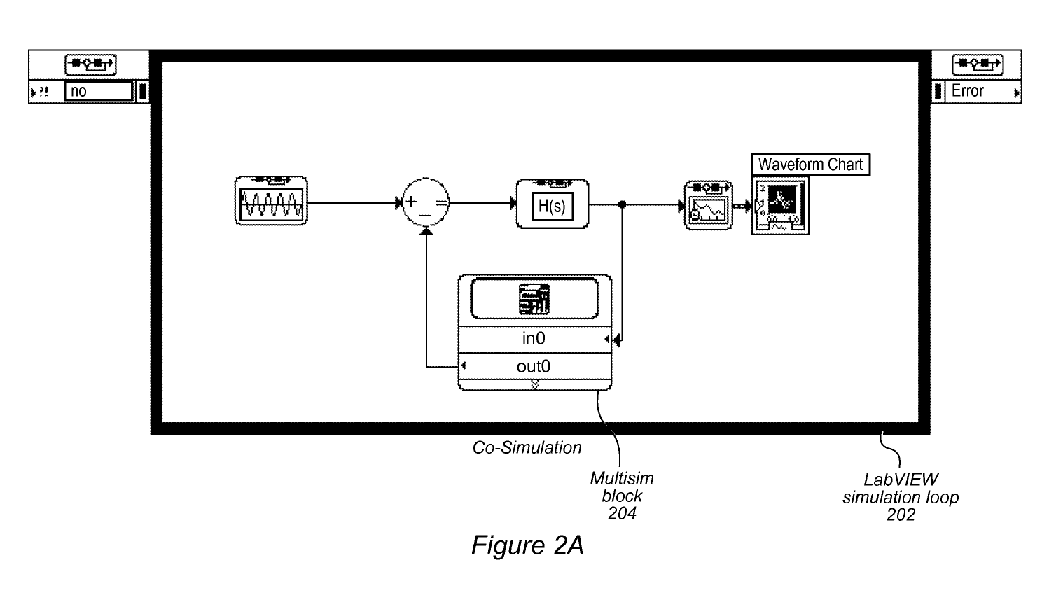

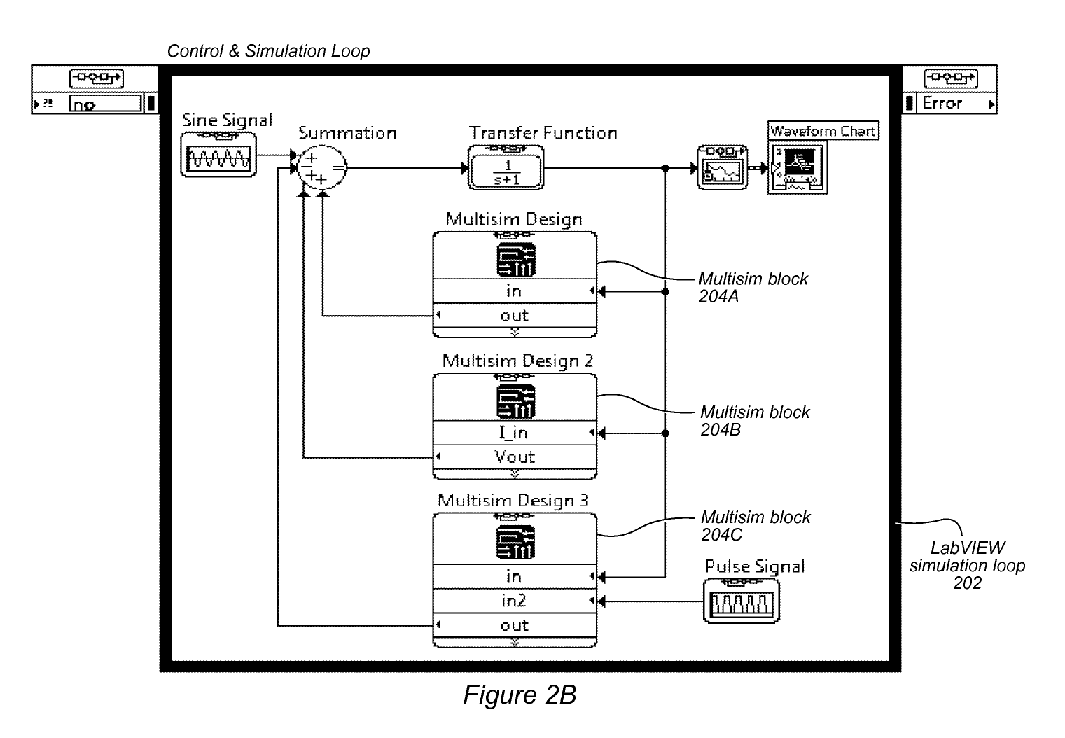

FIG. 2A—Exemplary Co-Simulation Program with Two Constituent Simulators

FIG. 2A is a screenshot of an exemplary co-simulation program (portion) that includes two constituent simulators. As may be seen, the co-simulation program is implemented via a graphical program implemented in the LabVIEW™ graphical programming development environment provided by National Instruments Corporation. In the embodiment shown, the LabVIEW simulator includes a simulation loop 202 with graphical simulation code contained therein, including a Multisim block 204 representing a Multisim circuit simulator. Multisim is a widely used circuit simulation system provided by National Instruments Corporation, and used for circuits education and electronic design (among other uses). Multisim may utilize SPICE (Simulation Program with Integrated Circuit Emphasis) to simulate electronic circuits. Note that for brevity, the terms “LabVIEW” and “Multisim” may be used to refer to their respective simulators (in addition to the environments under which they respectively execute).

During execution, the simulation loop executes the contained simulation code in an iterative manner, including the Multisim circuit simulator situated inside the LabVIEW simulation loop (via the Multisim block). More specifically, the simulation code (including the Multisim circuit simulator) may be executed once per each of a plurality of time steps. Note, however, that independent variables other than time may be used as desired, e.g., voltage, current, pressure, etc. In other words, in some embodiments the simulation may proceed based on time steps, while in other embodiments, the simulation steps may not be with respect to time.

Thus, the co-simulation program (portion) includes both a LabVIEW simulator and a Multisim simulator. Note that while the descriptions herein are with respect to a LabVIEW/Multisim co-simulation, the use of LabVIEW and Multisim simulators is meant to be exemplary only, and that other pairs or groups of simulators (e.g., of the same or different program types) may be used as desired.

FIG. 2B—Exemplary Co-Simulation Program with Four Constituent Simulators

FIG. 2B is a screenshot of an exemplary co-simulation program (portion) that includes four constituent simulators. More specifically, the exemplary co-simulation includes a LabVIEW simulator with simulation loop 202, similar to FIG. 2B, but in this embodiment, the graphical simulation code contained therein includes three different Multisim blocks, 204A, 204B, and 204C, representing respective Multisim circuit simulators.

As with the embodiment of FIG. 2A, during execution, the simulation loop executes the contained simulation code in an iterative manner, including executing all three of the Multisim circuit simulators situated inside the LabVIEW simulation loop (via the included Multisim blocks), once per each of a plurality of time steps.

Thus, the co-simulation program (portion) includes a LabVIEW simulator and multiple Multisim simulators. As noted above, while the descriptions herein are presented with respect to a LabVIEW/Multisim co-simulation, the use of LabVIEW and Multisim simulators is meant to be exemplary only, and that other pairs or groups of simulators (e.g., of the same or different program types) may be used as desired. For example, a co-simulation may include a LabVIEW simulator, two Multisim simulators, and another simulator of yet a third type.

It should be noted that in various embodiments, one or more of the simulators in the co-simulation may be directed to a particular application domain. For example, as noted above, Multisim is generally directed to simulating electronic circuits (e.g., via a SPICE circuit simulation program). Note, however, that in some embodiments, one or more of the simulators may not be domain specific, e.g., may be broadly applicable to numerous different domains. An example of this kind of simulator is LabVIEW (or, more specifically, the LabVIEW simulator), which is not restricted to any particular domain, i.e., it can be used to solve mechanical, chemical, thermodynamic, etc. engineering problems, among others. More generally, the LabVIEW simulator may be able to perform or implement a transient simulation of any system that can be represented using mathematical equations. Note that in some embodiments, while the LabVIEW simulator may not specialize as a solver in any one of these domains (in that it may not include domain specific libraries or data analysis tools, e.g., for chemical processes), if a user creates or otherwise obtains their own (e.g., domain specific) model, they may be able to simulate the system using the LabVIEW simulator.

Thus, in some embodiments, the first simulator and the second simulator may each be directed to a different respective application domain. Moreover, the different domains contemplated may be of any type desired. For example, in one embodiment, the different respective application domains may include two or more of: mechanical, chemical, electronic, electrical, hydrodynamic, thermodynamic, or control, among others.

Further regarding embodiments utilizing the External Modeling Interface (EMI), note that since EMI is a publically available interface, in some embodiments other companies or vendors (or entities, e.g., academic groups) may plug some other simulator into the co-simulation. Thus, the co-simulation may include multiple specialized simulators, each used to simulate systems in a particular domain, and each possibly provided by a different entity/company. For example, a Multisim simulator may simulate the electrical domain, a SolidWorks simulator may simulate the mechanical domain, and a LabVIEW simulator may have or provide the control code. The various simulators may be able to communicate with each other via an interface, discussed in detail below.

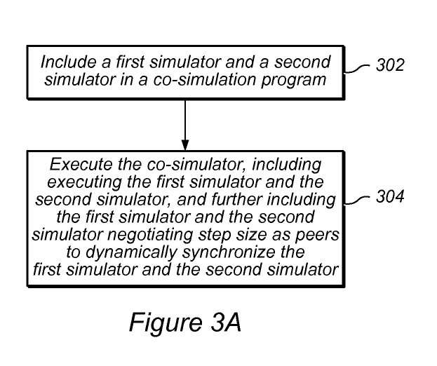

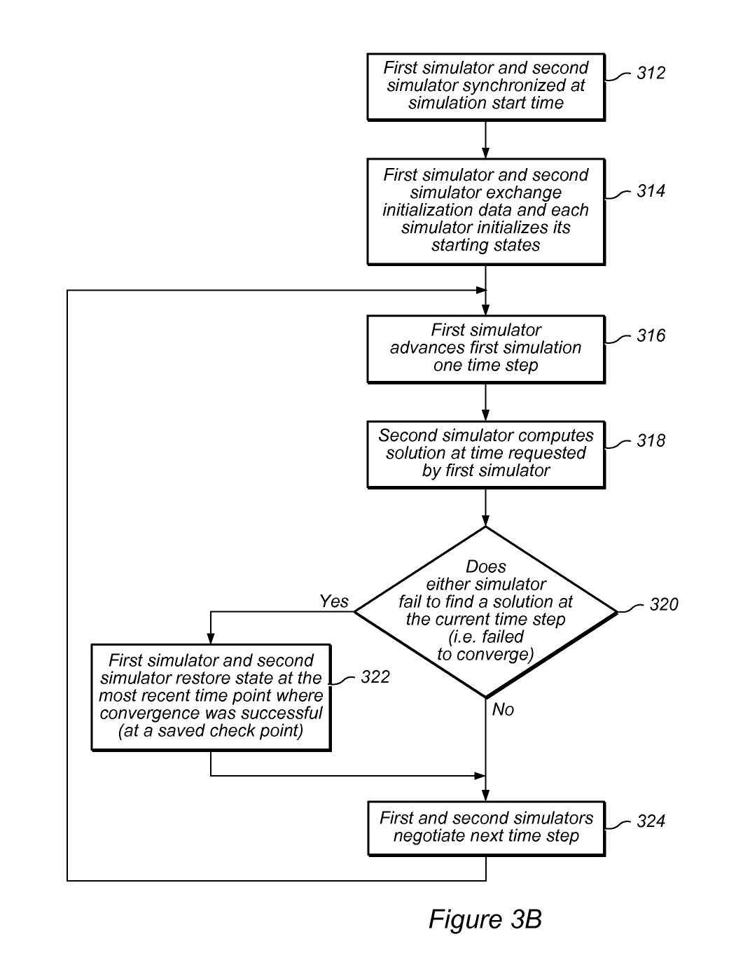

### FIG. 3A—High-Level Flowchart of a Method for Co-Simulation

FIG. 3A illustrates one embodiment of a method for co-simulation. The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 302, a first simulator and a second simulator may be included in a co-simulation program (co-simulator). The first and second simulators may be developed and/or may execute under different development environments. For example, in one exemplary embodiment, the first simulator may be a LabVIEW simulator, e.g., operating under the LabVIEW graphical program development environment, and the second simulator may be a Multisim simulator, e.g., executing a circuit simulation developed under the Multisim development and/or execution environment. As noted above, any other types of simulators may be used as desired. Additionally, more than two simulators may also be used as desired. In other words, the various techniques disclosed herein are broadly applicable to co-simulations with any number of simulators or instances of such.

In 304, the co-simulation program may be executed. Executing the co-simulation program may include executing the first simulator and the second simulator, where during execution, the first simulator receives input from the second simulator and provides output to the second simulator, and the second simulator receives input from the first simulator and provides output to the first simulator. Executing the co-simulation program may further include the first simulator and the second simulator negotiating step size as peers to dynamically synchronize the first simulator and the second simulator.

In other words, the first and second simulators may negotiate with each other as peers to determine a step size that is acceptable to both programs. Moreover, this negotiation may occur repeatedly as the co-simulation executes, thereby keeping the two simulators synchronized. Note that the determined step size may change over the course of execution of the co-simulation program. For example, in one embodiment, the step size may be negotiated (determined) for each cycle (step) of the co-simulation.

Note that the techniques disclosed herein may be applied or extended to three or more simulators. Thus, in one embodiment, the co-simulation program further comprises at least one third simulator. Execution of the co-simulation program may thus further include executing the at least one third simulator, during which the first simulator or the second simulator receives input from the at least one third simulator and provides output to the at least one third simulator, and the at least one third simulator receives input from the first simulator or the second simulator and provides output to the first simulator or the second simulator. Moreover, during execution, the first simulator, the second simulator, and the at least one third simulator may negotiate step-size as peers to dynamically synchronize the first simulator, the second simulator, and the at least one third simulator.

Moreover, in one embodiment, the first simulator, the second simulator, and the at least one third simulator can each reject a step-size for the co-simulation, in response to which the first simulator, the second simulator, and the at least one third simulator renegotiate a step-size for the co-simulation. Accordingly, the first simulator, the second simulator, and the at least one third simulator may utilize variable step-size solvers.

Similar to the above, in some embodiments, at least two of the first simulator, the second simulator, and the at least one third simulator may each be directed to a different respective application domain, where, for example, the different respective application domains may include two or more of: mechanical, chemical, electronic, electrical, hydrodynamic, thermodynamic, or control, among others. In some embodiments, the second simulator, and the at least one third simulator are each directed to a different model in the same application domain. In a more specific embodiment, the second simulator, and the at least one third simulator are each directed to a different electronic circuit. This may also apply to different instances of the same simulator.

FIG. 3b—Mid-Level Flowchart of a Method for Co-Simulation

FIG. 3B illustrates another embodiment of a method for co-simulation. The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 312, a first simulator and a second simulator may be synchronized at or to a simulation start time. In one exemplary embodiment, the first simulator may be a LabVIEW simulator, and the second simulator may be a Multisim simulator, although, as noted above, other simulators may be used as desired. Note that the two simulators may be executing as part of a co-simulation, and further, that each simulator includes or executes a respective simulation, i.e., the program or programs that model or simulate a system or sub-system.

In 314, the first simulator and the second simulator may exchange initialization data, and each simulator may initialize its starting states. For example, in one embodiment, the first simulator (e.g., LabVIEW simulator) may provide one or more initial values (i.e., initial values for the first simulator) to the second simulator (e.g., Multisim), and the second simulator may determine at least one of its initial values (i.e., initial values for the second simulator) based on the provided (one or more) initial values. In other embodiments, the second simulator may provide (one or more of its) initial values to the first simulator, and the first simulator may determine at least one of its own initial values accordingly. Alternatively, or additionally, each simulator may provide initial values to the other simulator(s), and each simulator may determine at least one of its own initial values accordingly.

In 316, the first simulator may advance the first simulation one time step (or, in some other embodiments, one step with respect to some other independent variable, e.g., temperature, pressure, altitude, mass, etc.).

In 318, the second simulator may compute a solution at a time requested by the first simulator. In other words, the second simulator will evaluate a solution at the current time of the first simulator (which was advanced in 316), where the solution is or includes a set of simulator (parameter) values that meet the user's criteria for the system design.

In 320, a determination may be made as to whether either simulator fails to find a solution at the current time step, i.e., whether either simulator fails to converge on a solution for the current time. Each simulator may perform an iterative process to successively improve a solution until convergence is achieved. Since determining an exact solution to an integrative problem is generally not feasible, by using an iterative approach the simulators attempt to get sufficiently close to the solution for a particular required level of accuracy (controlled by simulator parameters). If after performing a maximum allowed number of integrations, the iterative process fails to find a solution that meets the required level of accuracy, the simulator has failed to find a solution at that time step. If this happens the simulators may try a smaller step size.

If it is determined in 320 that either simulator failed to converge, then in 322, the first simulator and the second simulator may restore state (i.e., their respective state information) at the most recent time point (time step) where convergence was successful, e.g., at a saved check point. In other words, each simulator may restore its state to the last point in time where solutions were found, after which the method may proceed to method element 324, as shown.

If, on the other hand, it is determined in 320 that neither simulator failed to converge, i.e., that both simulators found a solution at the current time step, then the method may proceed to method element 324, as indicated in FIG. 3B.

In 324, the first and second simulators may negotiate the next time step. In other words, the simulators may collectively determine the next time step, i.e., the next step size to take. The method may then return to method element 316 for the next iteration of the co-simulation.

Thus, in one embodiment, when one or both simulators fail to find a solution for their respective simulations, they may negotiate a new time step (as peers), and proceed from the most recent valid state accordingly. The method (and thus, the co-simulation) may iterate as described above until some stopping condition is met.

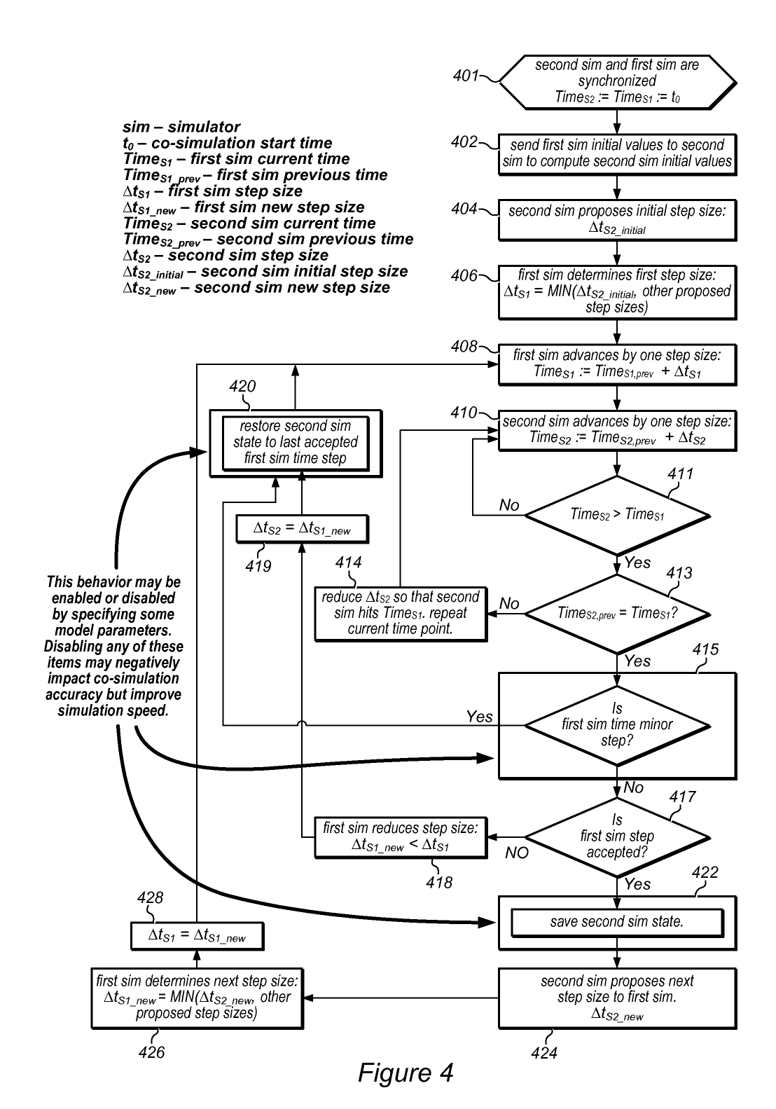

The above peer negotiated step size determination may be made in any of a variety of ways. FIG. 4 is a more detailed flow chart of one embodiment of a method for such peer negotiated step size determination in a co-simulation.

### FIG. 4—Peer Negotiation of Step Size in a Co-Simulation

FIG. 4 is a flowchart diagram illustrating one embodiment of a method for peer negotiation of step size among simulators (also referred to as simulation programs) in an executing co-simulation program (or co-simulation). It is noted that some method elements in the following flowchart may occur concurrently or in different orders than that shown, or may be omitted. Additional method elements may also be performed as desired. It should be noted that while the below method is described in terms of a co-simulation that includes two simulations (or sub-simulations), in other embodiments, more than two simulations (or sub-simulations) may be used. Note further that the terms “first simulator” and “second simulator” are used simply to distinguish between the two simulations in the co-simulation, and are not intended to indicate any particular distinctions or relationships between them, nor any particular attributes of either. Additionally, in other embodiments, more than two simulators may be included in the co-simulation program, and thus the peer negotiation of the step size may be among more than two simulators.

In 401, a first simulator and a second simulator may be synchronized to an initial time, e.g., time=t_{S1}=t_{S2}=t₀, where S₁ and S₂ denote the first and second simulators, respectively. The first and second simulators may be executing as, or as part of, a co-simulation, in which during execution the first simulator receives input from the second simulator and provides output to the second simulator, and the second simulator receives input from the first simulator and provides output to the first simulator. Note that the two simulators may each be of any of various types, as noted above.

In 402, the first simulation's initial values (e.g., signal values) may be sent to the second simulation so that the second simulation can correctly compute its own initial values, e.g., one or more values for its own operation, e.g., a DC (direct current) operating point. More generally, to ensure that the co-simulation operates with consistency between its constituent simulations, initial signal (or other data) values of one simulation may be sent to the other simulation(s) for coordinated or consonant initialization. In other words, in some embodiments, at least one of the first simulator or the second simulator is configured to provide one or more initial values to the other of the first simulator or the second simulation, and wherein the other of the first simulator or the second simulator is configured to determine at least one of its initial values based on the provided one or more initial values. It should be noted that in various embodiments, any of the features disclosed herein regarding two simulators (or instances of simulators) may be extended to three or more simulators.

In 404, the second simulator, S₂, may propose an initial step size, e.g., Δt_{S2}_{_{—}}ᵢₙᵢₜᵢₐₗ. The proposed initial step size may be based on historical data, a heuristic, or another model, may be received from an external source, etc., as desired. Note that generally step size refers to a time increment, but that in some cases, the step size may be or include an increment of some other independent variable, e.g., distance, voltage, etc., as desired, depending on the model(s).

In 406, the first simulator, S₁, may determine a first step size, e.g., Δt_{S1}. For example, in one embodiment, the step size may be set to the minimum of the proposed step size of the second simulator and one or more other proposed step sizes, e.g., derived via other methods, such as a heuristic, historical values, etc., e.g., Δt_{S1}=MIN(Δt_{S2}_{_{—}}ᵢₙᵢₜᵢₐₗ, other proposed step sizes).

In 408, the first simulator, S₁, may advance by one first step size, where the first step size is specific to the first simulator, e.g., Δt_{S1}. Thus, after the advancement, the time of the first simulator, time_{S1}=t₀+Δt_{S1}, or, more generally, time_{S1}=t_{S1,prev}+Δt_{S1}. It should be noted that in this case, “first” simply designates the step size as being that of the first simulator.

In 410, the second simulator may advance by one second step size, where the second step size may be specific to the second simulator, e.g., Δt_{S2}. Thus, after the advancement (from the initial time t₀), the time of the second simulator, time_{S2}=t₀+Δt_{S2}, or, more generally, time_{S2}=t_{S2,prev} Δt_{S2}. Similar to the above, in this case, “second” simply designates the step size as being that of the second simulator.

In 411, a determination may be made as to whether the current time of the second simulator is greater than that of the first simulator, e.g., if time_{S2}>time_{S1}.

If in 411, it is determined that the current time of the second simulator is not greater than that of the first simulator, the method may proceed back to 410, and continue as described above.

Conversely, if in 411, it is determined that the current time of the second simulator is greater than that of the first simulator, then in 413, a determination may be made as to whether the (immediately) previous time of the second simulator is equal to the current time of the first simulator, e.g., t_{S2,prev}==t_{S1}.

If in 413, it is determined that the previous time of the second simulator is not equal to the current time of the first simulator, then in 414, the step size of the second simulator, e.g., Δt_{S2}, may be reduced (e.g., by the second simulator) such that the second simulator's time (when advanced) will coincide with that of the first simulator. Note that since the second simulator's time was already advanced in 410, this may entail a reduction or subtraction in the current time of the second simulator. For example, the method may back the second simulator up to the previous time step, e.g., t_{S2,prev}, then, instead of advancing by Δt_{S2}, the method may apply the reduced step size to hit the first simulator's current time precisely. In other words, 414 may entail a reduction in current time for the second simulator back to before the advancement of 410, then application of the new reduced time step, Δt_{S2}_{_{—}}_{new}<Δt_{S2}. The method may then proceed back to method element 410, and continue as described above.

Conversely, if in 413, it is determined that the previous time of the second simulator is equal to the current time of the first simulator, then in 415, a determination may be made as to whether the first simulator's current time is a minor step. As used herein, the term “minor step” refers to a time step that is in addition to major time steps in the simulation. A time step at time t+Δt is a major time step of the ODE solver. ODE solvers may need to evaluate the simulation multiple times between major time steps. A time step at these intermediate evaluation times is a minor time step of the ODE solver. As another example, there may be some processes in the simulation that operate according to larger, i.e., major, time steps, and other processes, e.g., submodels, that may operate according to smaller, i.e., minor, time steps. Thus, computations may be made at minor time steps in addition to those made at major time steps. Thus, there may be one or more minor (intermediate) time steps between (or associated with) major time steps. However, note that in some embodiments, one or more of the minor time steps may not fall between the major time step time values, i.e., may not have intermediate values with respect to the values of the particular pair of major time steps being considered.

If in 415, it is determined that the first simulator's current time is a minor step, then in 420 the second simulator state may be restored to that of the last accepted step of the first simulator, and the method may proceed back to 408, and continue as described above. Note that in some embodiments, the “Is first sim time minor step?” determination option of 415 may be enabled in conjunction with the optional “save second sim state” and “restore second sim state to last accepted first sim time step” states of 420 and 422, described herein.

Conversely, if in 415, it is determined that the first simulator's current time is not a minor step, then in 417, a determination may be made as to whether the first simulator's step (e.g., time advancement) is accepted.

If in 417, the first simulator's step is not accepted, then in 418, the step size of the first simulator may be reduced, e.g., Δt_{S1}_{_{—}}_{new}<Δt_{S1}, and the second simulator's step size may be set to the reduced value, as indicated in 419, e.g., Δt_{S2}=Δt_{S1}_{_{—}}_{new}. Once the step size of the first simulator has been reduced and the step size of the first and second simulators set, then the method may proceed to 420 and continue as described above.

If in 417, the first simulator's step is accepted, then in 422, the state of the second simulator may be saved.

In 424, the second simulator may then propose a next step size to the first simulator, e.g., Δt_{S2}_{_{—}}_{new}, and proceed to 426.

In 426, the first simulator may determine a next step size, e.g., Δt_{S1}_{_{—}}_{new}. For example, in one embodiment, the next step size may be set to the minimum of the next (new) step size of the second simulator and one or more other proposed step sizes, e.g., derived via other methods, such as a heuristic, historical values, etc., e.g., Δt_{S1}=MIN(Δt_{S2}_{_{—}}_{new}, other proposed step sizes).

In 428, the step size of the first simulator may be set to the next or new step size determined in 426, e.g., Δt_{S1}=Δt_{S1}_{_{—}}_{new}, and the method may proceed to 408 and continue as described above.

In one embodiment, the method may further include the ability for the second simulator to notify the first simulator that the second simulator rejected a time step (just like the first simulator, the second simulator can reject a time step if the solution does not satisfy the convergence criteria after a certain number of iterations). The behavior may be similar to what happens when the first simulator rejects a time step; however, in other embodiments, the behavior may be different. This option may be turned on/off in order to balance simulation speed against accuracy. In one embodiment, to help minimize the number of rejected time steps, an extrapolation routine may be used to predict the inputs to the second simulator block for the upcoming first simulator's time step. Feeding these predicted values into the second simulator convergence algorithms may allow further refinement of the step size that the second simulator suggests to the first simulator.

Accordingly, in some embodiments, the first simulator and the second simulator can each reject a step-size for the co-simulation, in response to which the first simulator and the second simulator renegotiate a step-size for the co-simulation. Note that such negotiated step sizes may require the use of variable step-size solvers. Thus, in some embodiments, the first simulator and the second simulator (and possibly one or more third simulators) may utilize variable step-size solvers.

Thus, embodiments of the above method may be used to dynamically synchronize simulations in a co-simulation using variable step sizes, where the simulations perform peer negotiations to set their respective step sizes to execute the co-simulation in lock-step. Note that using the above method, during execution of the co-simulation both simulations (which may also be referred to as simulators) are active participants allowing for joint step-size negotiation. Unlike many prior art tools, in embodiments of the co-simulation techniques described herein, there is no master simulation or simulator—both are equally involved in the (co-)simulation execution, and the mutual participation results in lock-step simulation which produces very accurate results. Thus, in addition to ensuring synchronization, joint step size negotiation may guarantee that any rapid signal transitions (requiring small step sizes) in one simulator may be communicated through the interface to the other simulator(s), thereby ensuring accuracy during co-simulation.

Thus, in the co-simulation technique disclosed herein, the two (or more) simulators jointly negotiate step size, e.g., time stepping. Such peer negotiated step determination may facilitate the use of different types of simulations together, where each simulator may have particular strengths. For example, a co-simulation with LabVIEW and Multisim simulators may allow the LabVIEW simulator to do what it does well, which is system simulation, while also allowing the Multisim simulator to do what it does well, which is analog circuit simulation.

### Example Embodiments

The following describes specific embodiments of the above method, although the embodiments described are exemplary only, and are not intended to limit the invention to any particular form, function, or appearance, nor the simulators to any particular type of simulations. In other words, in different embodiments, the simulators may be developed under various different development environments, and may operate according to various different rules, protocols, or models of computation. The descriptions of the below embodiments are in terms of LabVIEW and Multisim simulators/environments, but may apply more generally to first and second simulators/environments, respectively.

In one exemplary embodiment, the co-simulation may be a lock-step co-simulation where the first simulator may be a LabVIEW simulation, which is an ordinary differential equation (ODE) solver, e.g., developed under the LabVIEW™ program development environment provided by National Instruments Corporation, and the second simulator may be a Multisim simulator, which is a circuit (schematic) design and simulation tool that includes or utilizes a SPICE/XSPICE based circuit simulator.

In some exemplary embodiments, the user may configure a Multisim circuit (schematic) design for co-simulation by identifying the inputs and outputs, i.e. the signals that are exchanged between Multisim and LabVIEW. The user may then place a Multisim block (the Multisim simulation) in a LabVIEW simulation loop (i.e., in a LabVIEW simulation), select the pre-configured Multisim file for co-simulation, and the Multisim block may be auto-configured with the appropriate inputs and outputs.

Note that in this embodiment, the Multisim block (or more generally, the second simulator/simulation) has direct feedthrough. This means that the block's inputs at the current time step are required to calculate its outputs at the current time step. Consider a simulation function with input u and output y. If output y requires the input u in order to execute, u has direct feedthrough to y. One cannot create a feedback cycle between inputs and outputs with direct feedthrough. Note, however, that in other embodiments, the Multisim block (or more generally, the second simulator/simulation) may have indirect feedthrough. This means that the block's inputs at the current time step are not required to compute its outputs at the current time step. Consider a simulation function with input u and output y. When indirect feedthrough exists between u and y, one can create a feedback cycle between these parameters. In a feedback cycle, the value of y at time t relies on the value of u at time ‘t−dt’, ‘t−dt2’, and so on.

In either case, in some embodiments, Multisim (or the second simulator) may maintain its own internal states, and may appear to LabVIEW (or the first simulator) as a simple LabVIEW primitive.

Note that in some embodiments, the interface between the two simulation environments does not require special bridge elements to perform signal value translations. Thus, the Multisim simulation may send voltages and currents directly to the LabVIEW simulation, and vice-versa. In other words, in some embodiments, the co-simulation program may include a communication interface for communication between the first simulator and the second simulator (discussed in more detail below), and analog signals or data may be communicated between the first simulator and the second simulator directly via the communication interface without requiring any bridge elements in the communication interface to perform value translations of the analog signals or data.

Alternatively, in some embodiments, the communication interface may include a bridge element for translating values of digital signals or data, and digital signals or data may be communicated between the first simulator and the second simulator via the communication interface using a bridge element in the communication interface to perform value translations of the digital signals or data. In some embodiments, bridge elements may only be used when passing Multisim simulation digital data to the LabVIEW simulation, although in other embodiments, the inputs to the (LabVIEW embedded) Multisim block may behave as digital signals in Multisim, in which case bridge elements may be used.

In some embodiments, Multisim may be running silently, i.e., passively, and any errors and warnings from Multisim may be forwarded through a communication interface, discussed below, and presented to the user in LabVIEW. More generally, in embodiments where one of the simulations or simulation environments (e.g., Multisim) is passive regarding interactions with the user, the other simulation or simulation environment (e.g., LabVIEW) may provide means for communications between the user and both simulations/environments. Thus, errors or warnings (or any other messages directed to the user) from Multisim may be channeled through LabVIEW to the user. In one embodiment, such communications may be labeled or otherwise indicated as being from Multisim (or LabVIEW, as appropriate), i.e., the origin of messages may be indicated. Said another way, in some embodiments, the second simulator may execute in the co-simulation program passively, where during execution, errors and warnings from the second simulator may be forwarded through the communication interface and presented via the first simulator.

In one embodiment, in Multisim, the LabVIEW model does not load the analog circuitry designed in Multisim; the inputs to the LabVIEW model (in Multisim) may have infinite input impedance, and the outputs may have zero output impedance.

The Multisim simulation may save checkpoints at appropriate times, so that it can restore state as required to ensure accuracy of the LabVIEW solver(s) (see, e.g., method element 422 in FIG. 4, described above). In one embodiment, the above described co-simulation system may be built upon an External Modeling Interface (EMI), which is part of the LabVIEW Control Design and Simulation module, provided by National Instruments Corporation.

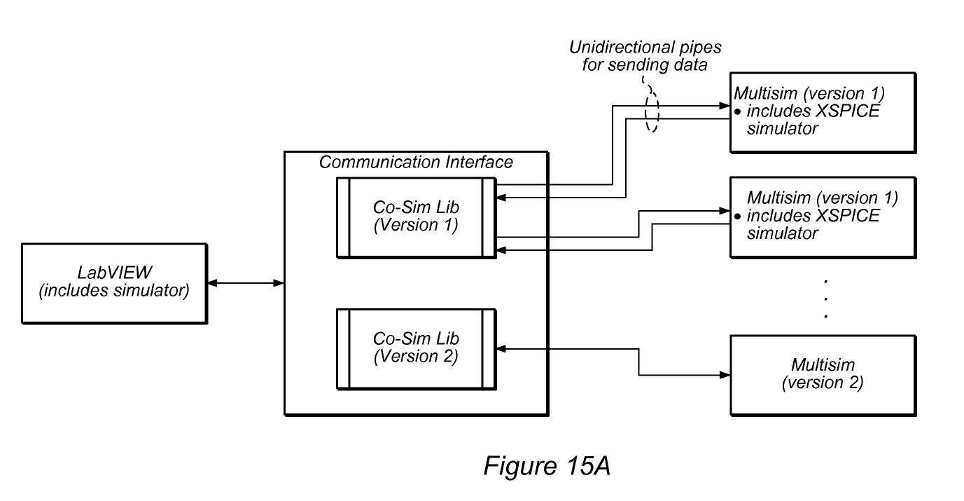

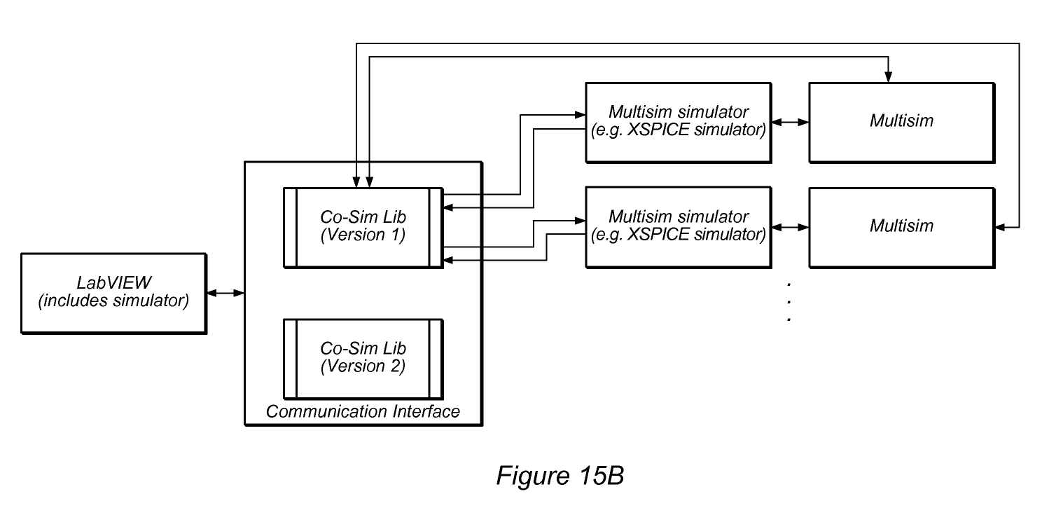

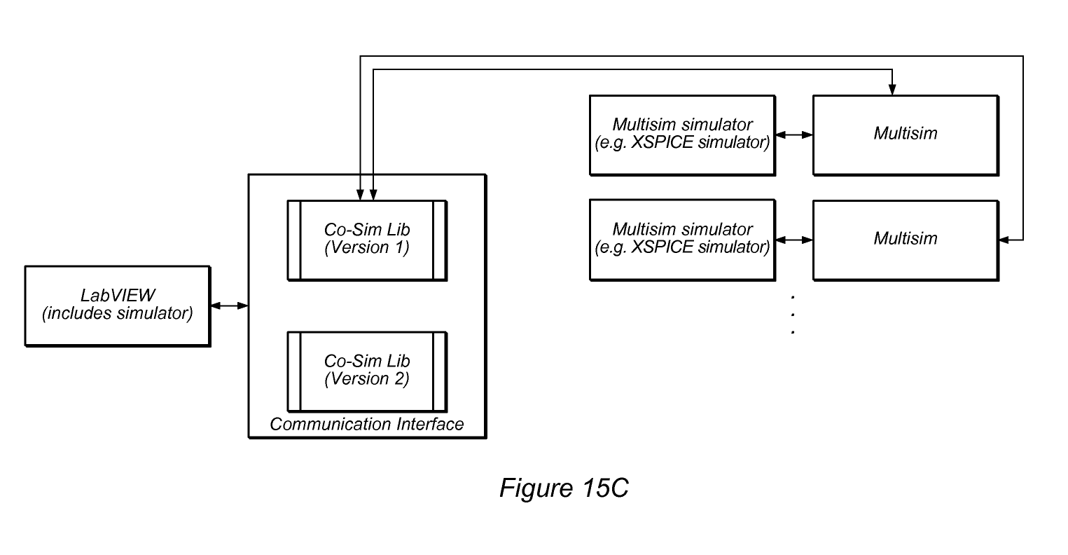

As mentioned above with respect to FIG. 2B, in some embodiments, the co-simulation may include or accommodate multiple concurrent instances of the second (e.g., Multisim) simulator (or, in further embodiments, of a third simulator, or of the first simulator, and so forth). Furthermore, each instance may be configured with a different (Multisim) schematic file. This is illustrated in FIGS. 2B and 15A-15C. This functionality may be provided by each Multisim block (in LabVIEW) spawning a separate Multisim simulator. As in the case with embodiments that only include a single Multisim simulation instance, each Multisim block may be able to negotiate the step size. The final accepted step size may be the minimum of all the suggested step sizes (e.g., as per the LabVIEW/first simulator environment).

Moreover, the co-simulation may support some or all LabVIEW solvers. Note, however, that to achieve substantially perfect accuracy, i.e., very high accuracy, for all LabVIEW solvers, the optional “Is first sim time minor step?” of 415 may need to be enabled (e.g., in conjunction with the optional “save second sim state”/“restore second sim state to last accepted first sim time step” states of 420 and 422), as noted above. Co-simulation accuracy may be measured by comparing the behavior of:

1. a Multisim block, and

2. an equivalent model built in LabVIEW using LabVIEW native elements (this can be done for very simple Multisim models only).

When this “Is first sim time minor step?” option is enabled, the Multisim simulator may restore state after the completion of each LabVIEW minor time step to the value it was at the previous accepted LabVIEW step (i.e. the previous major time step). When this option is disabled, accuracy may be degraded for any solver where:

1. a minor step occurs at the same position as another minor step;

2. a minor step occurs at the same position as a major step.

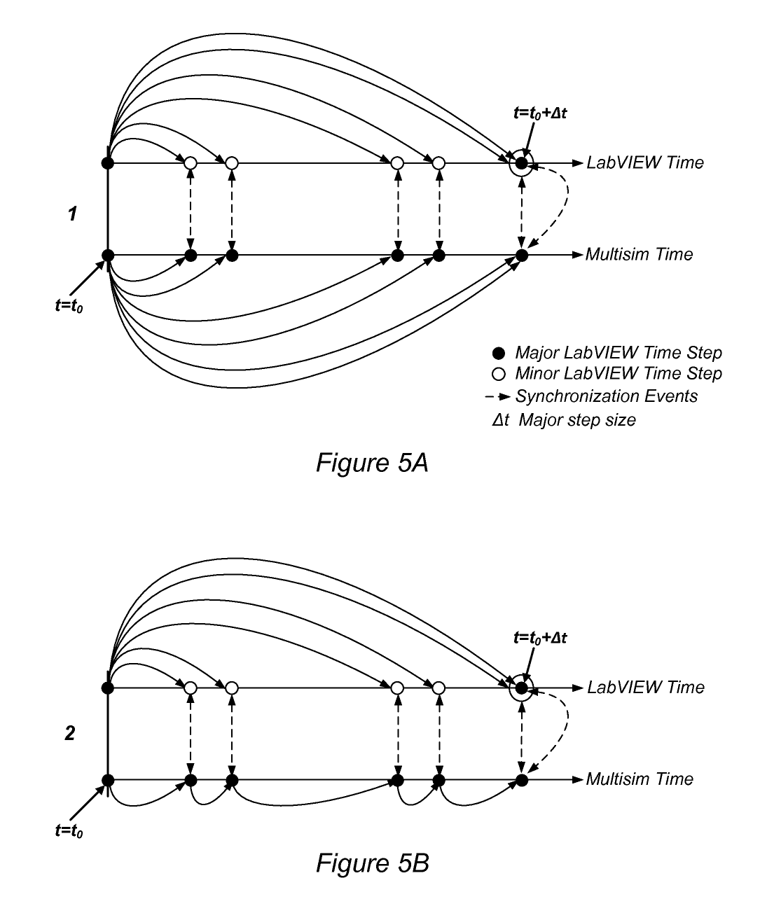

This may occur for a number of solvers, including, for example: Runge-Kutta 45, BDF (backward differentiation formula), Adams-Moulton, and Rosenbrock, among others. The effect of enabling/disabling this option for the Runge-Kutta 45 solver is illustrated in FIGS. 5A and 5B, which illustrate co-simulation time steps with and without enablement of a “Is first sim time minor step?” determination option, according to one embodiment of the invention. As noted above, this example is particularly directed to a co-simulation where a Runge-Kutta 45 solver is used. When the option is enabled, the resulting time-stepping in Multisim (the second simulator) may be like that shown in FIG. 5A. When the option is disabled, the time-stepping in Multisim (the second simulator) may be as shown in FIG. 5B. The actual negative impact to accuracy occurs when the last time step is evaluated because there is a minor time step that occurs at the same position as the major time step.

Note, for example, that for the RK45 algorithm applied to a LabVIEW/Multisim co-simulation, the coincidence of major/minor steps may cause problems because the LabVIEW simulator will evaluate twice at time t_{0+Δt}, while the Multisim simulator will evaluate only once—when the Multisim simulator reaches the time t_{0+Δt} it will stay there since the “Is first sim time minor step?” option is disabled. As such, the output values returned by the Multisim simulator to the LabVIEW simulator will be the same when the LabVIEW simulator requests the results for the final minor time step and the major time step. However, since the inputs the LabVIEW simulator provides during the evaluation of the final minor time step and the major time step are actually different, the outputs returned by the Multisim simulator should also be different. This is the source of the numeric inaccuracy when “Is first sim time minor step?” is disabled.

This issue may occur when using the Runge-Kutta 45, BDF, Adams-Moulton, and Rosenbrock solvers in LabVIEW. It should be noted that various of the nuances of the synchronization technique disclosed above are not illustrated in FIGS. 5A and 5B. Rather, these figures are intended to illustrate the different behavior in Multisim (the second simulator) when the “Is first sim time minor step?” option is disabled.

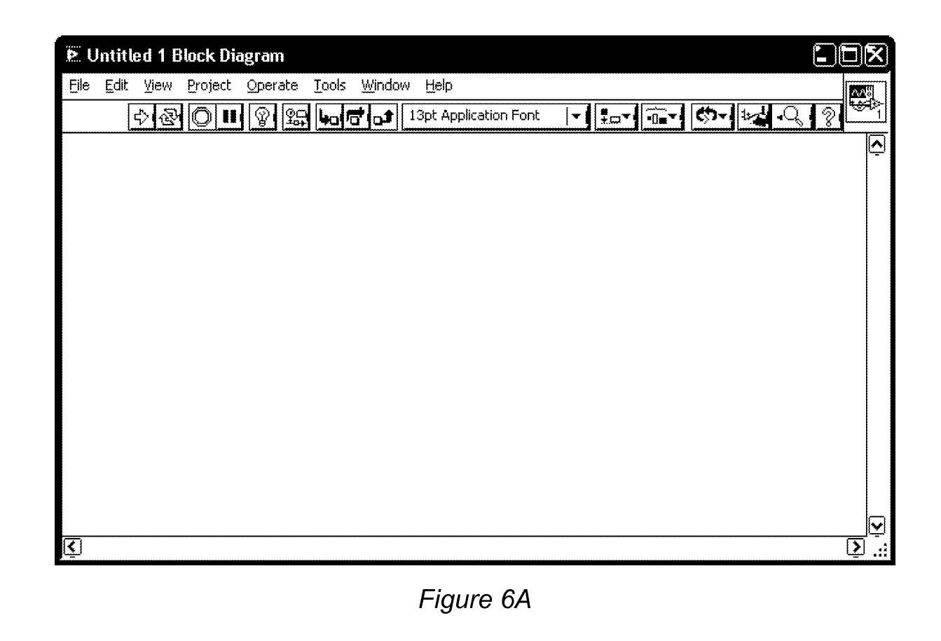

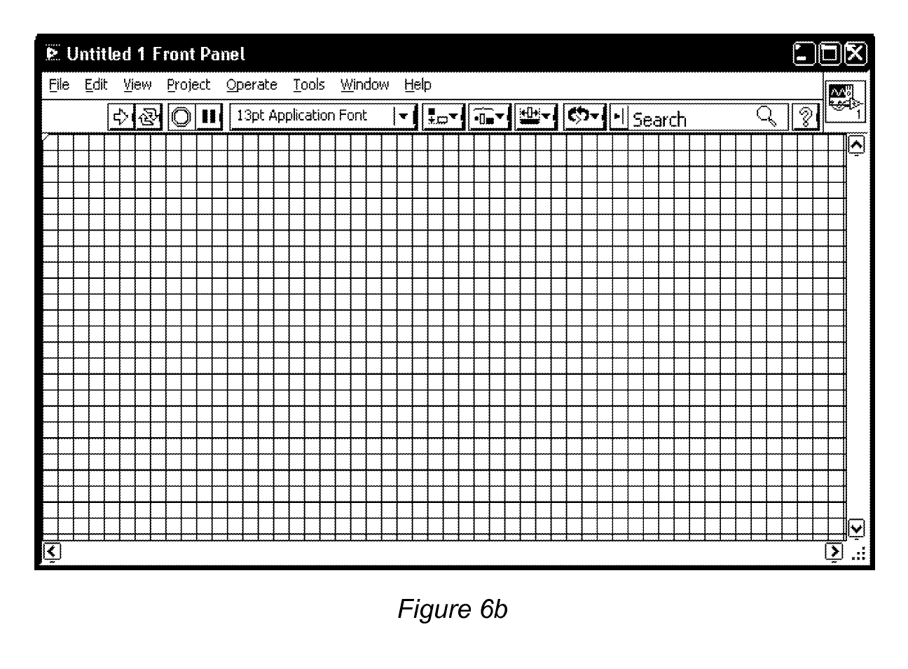

### FIGS. 6A-13—Creating the Co-Simulation Program

FIGS. 6A-13 illustrate creation of an exemplary co-simulation program, according to one embodiment.

FIG. 6A shows a blank LabVIEW graphical program window, e.g., a blank block diagram in a LabVIEW graphical program development environment. Similarly, FIG. 6B illustrates a blank front panel (graphical user interface (GUI)) for the (blank) block diagram of FIG. 6A. In this LabVIEW based example, the block diagram and the front panel compose a LabVIEW VI (virtual instrument);

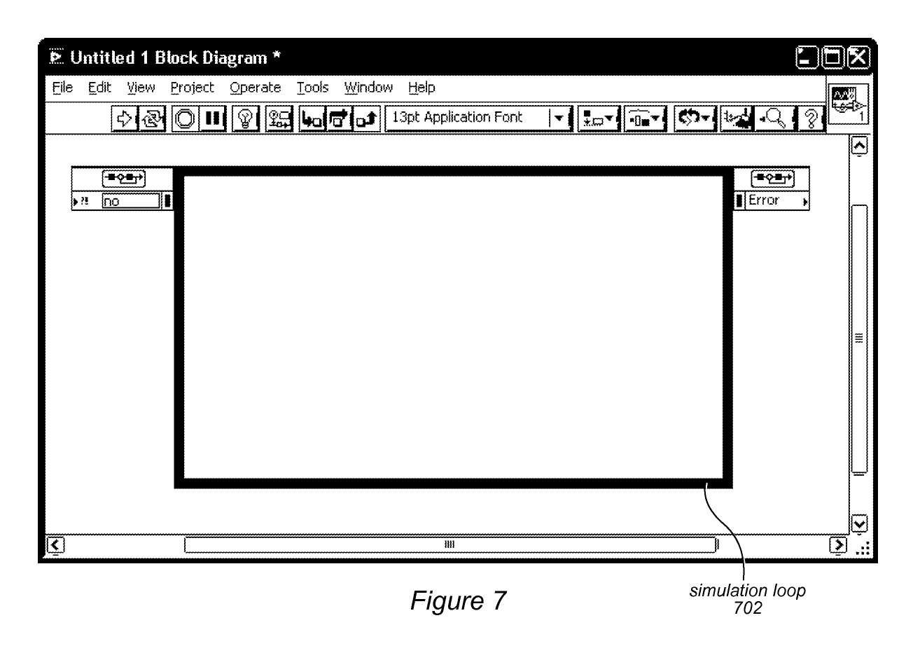

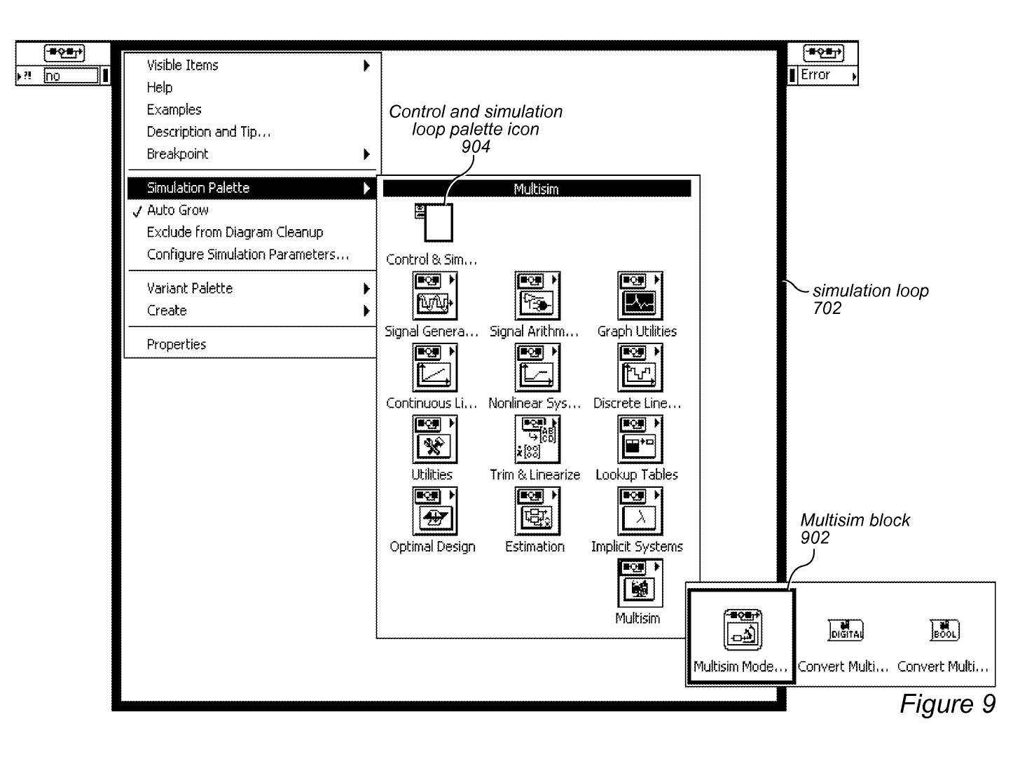

FIG. 7 illustrates the first (LabVIEW) simulator with a simulation loop, according to one embodiment. In other words, FIG. 7 shows the block diagram of FIG. 6A, but where a simulation loop 702 has been added. Any program code subsequently placed in the simulation loop will, upon execution of the block diagram, be executed in an iterative manner. Note that the simulation loop may be (or may have been) selected from a control design and simulation palette in the LabVIEW development environment, shown as control and simulation loop palette icon 904 (the top left block) inside the simulation pallet, as presented in FIG. 9.

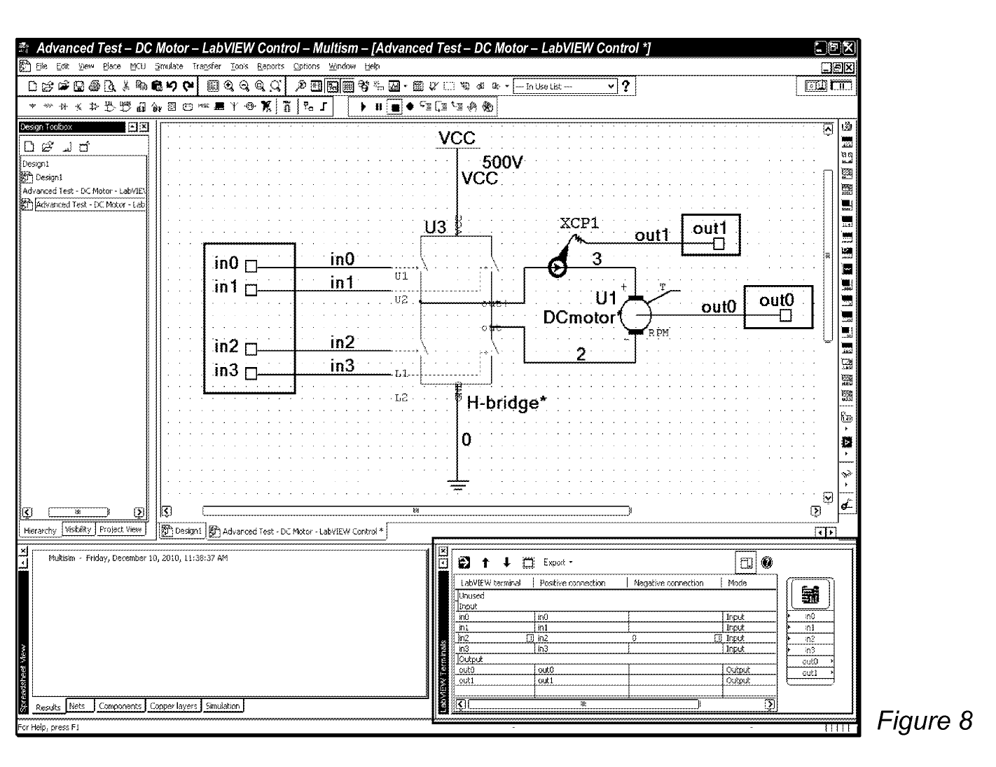

FIG. 8 illustrates a second (Multisim) simulator, according to one embodiment of the invention. As may be seen, this simulator is an analog circuit simulation developed under the Multisim development environment. Once the user has developed (or received and/or modified) the second simulator, the program may be saved in the form of a circuit simulation file. Of course, in other embodiments, the circuit simulation file itself may be received from some other source, and thus may not need to be saved.

FIG. 9 illustrates selection of a Multisim block 902 from a palette, according to one embodiment. Note that in the embodiment shown, the Multisim block is initially “blank”, in that a Multisim simulator has not been associated with it. In other words, a generic Multisim block may be selected, e.g., from a Multisim palette. As with other simulation blocks, in some embodiments, this block can only be placed inside the simulation loop. Note that this block is only a generic block—without configuration it does nothing, and will be configured in a later step.

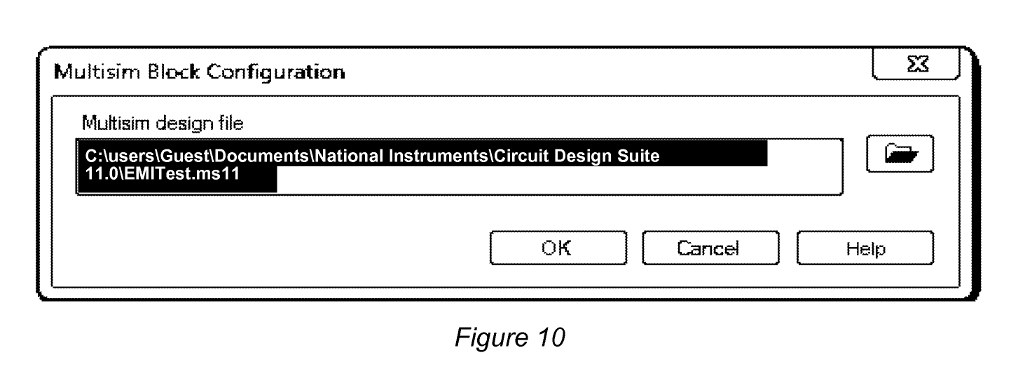

FIG. 10 illustrates designation of a circuit simulation file for the Multisim block of FIG. 9 from within LabVIEW, according to one embodiment. In this example, the circuit simulation file corresponds to the second (Multisim) simulator of FIG. 8. Once this designation is made, the Multisim block is associated with, and represents, the second (Multisim) simulator.

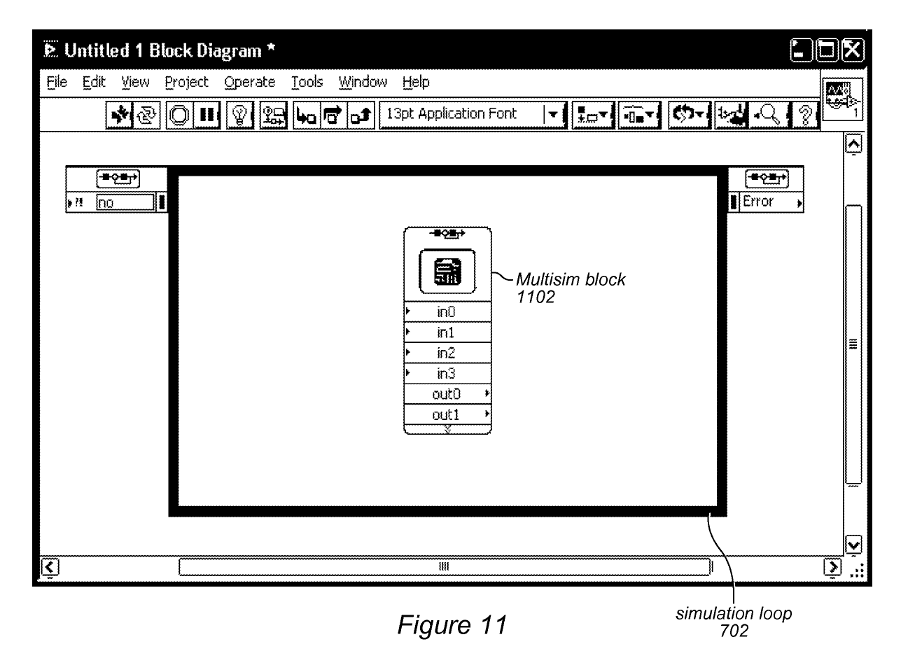

FIG. 11 illustrates placement of the Multisim block 1102 into the simulation loop 702 of the first (LabVIEW) simulator, according to one embodiment. In some embodiments, upon placement of the Multisim block in the simulation loop of the block diagram, the Multisim block configuration dialog may pop-up. The user may then select the file for co-simulation, e.g., per the GUI of FIG. 10.

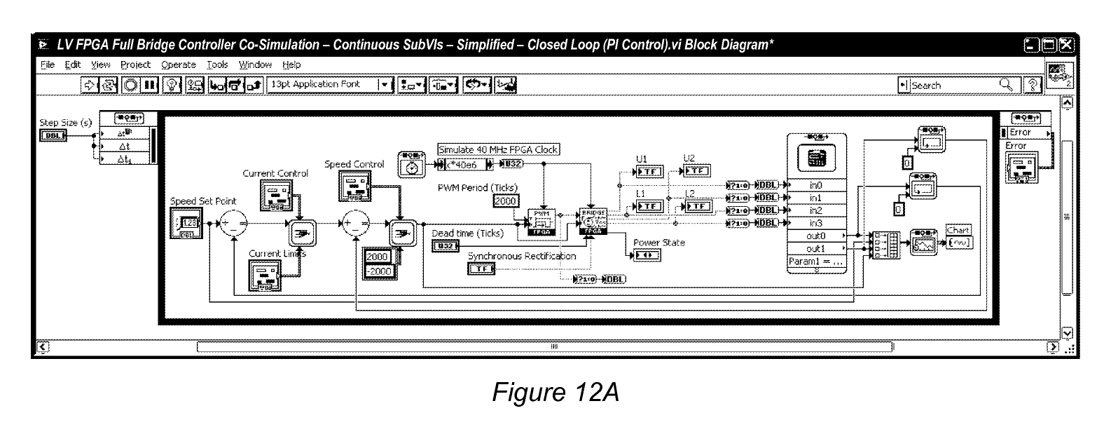

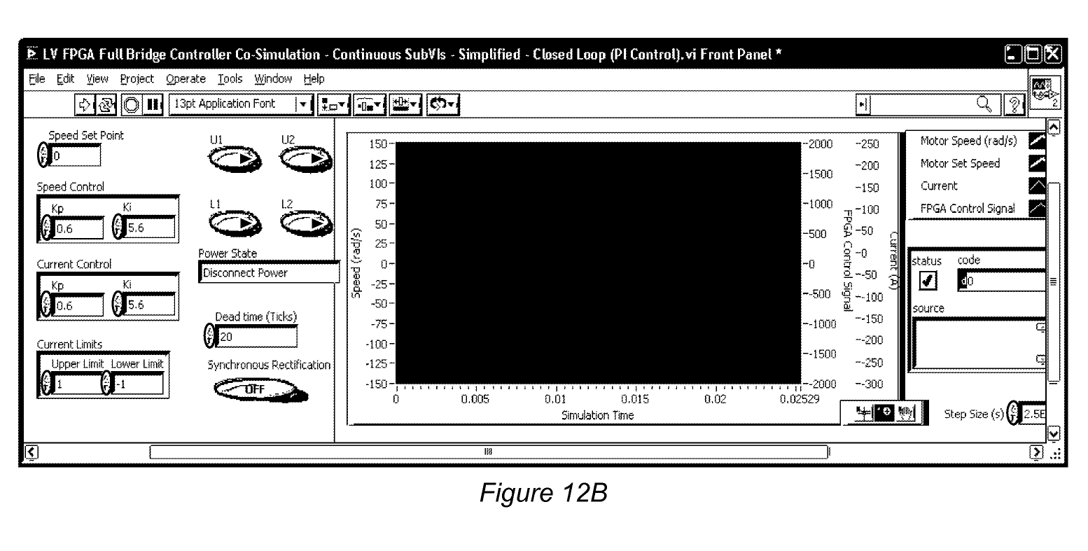

FIG. 12A illustrates the completed co-simulation program, including the first (LabVIEW) simulator with the second (Multisim) simulator contained within, according to one embodiment. Note that various additional graphical program elements (e.g., LabVIEW simulation code) have been added to the block diagram within the simulation loop, which are directly or indirectly coupled to the Multisim block. FIG. 12B illustrates the completed front panel for the co-simulation program of FIG. 12A, according to one embodiment. Note that the various controls and indicators of the front panel correspond to various of the program elements within the simulation loop, and thus may operate to set or display parameters for those program elements.

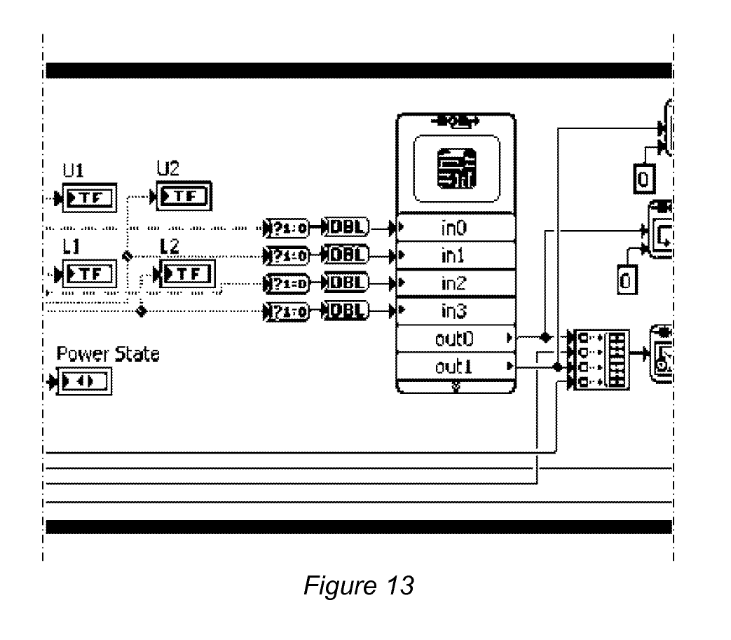

FIG. 13 illustrates a zoomed-in excerpt of the co-simulation program of FIG. 12A that shows I/O connections for the second (Multisim) simulator block, according to one embodiment. As may be seen, in this exemplary embodiment, the Multisim block takes four inputs in0-in3, and provides outputs out0 and out1, to program elements located to the right of the block, but still within the simulation loop.

Once the co-simulation program has been developed, the user may invoke execution of the program, e.g., via selection of a “Play” button, or equivalent.

### Further Embodiments

Below are described further embodiments of the above co-simulation techniques, although it should be noted that the embodiments described herein are meant to be exemplary only, and are not intended to limit the invention to any particular form, function, or appearance.

In one embodiment, the second simulator, e.g., the Multisim simulator, may run “silently”, i.e., passively. When running silently/passively the user will not be able to interact with the Multisim environment, and any simulation control will occur exclusively through LabVIEW. Alternatively, in other embodiments, the method may provide the ability to have the Multisim simulator running interactively with the LabVIEW simulator, or, more generally, the second simulator may execute interactively with the first simulator. In these embodiments, users may be able to: a) pause/stop simulation from either the LabVIEW or Multisim (or, more generally, the first or second) simulator (or environment), and b) dynamically change certain circuit parameters in the Multisim simulator (e.g. the resistance value of a variable resistor, whether an electrical switch is open or closed, etc.) while the co-simulation is running.

Parameters are used to define values that can be used during simulation. Parameters can be constants, expressions, and even expressions that included other parameters. Changing these parameters in the Multisim simulator may have an immediate effect in LabVIEW.

In some embodiments, the parameters of the second simulation (e.g., Multisim/SPICE) may be accessible via the first simulation or its environment (e.g., LabVIEW).

SPICE parameters can be defined via a .PARAM statement. The following are examples of parameter definitions for the SPICE simulation (operating under Multisim):
.PARAM a=6
.PARAM n={0.5̂2}
.PARAM maxRes=a+10

Once such parameters are defined, they may be used in the Multisim/SPICE simulation. The following is an example of the use of a defined SPICE parameter:
R3 node1 node2 {maxRes}

In this example, parameter maxRes defines the value of a resistor, R3.

In one exemplary embodiment, support for Multisim .PARAM functionality may be provided directly from the LabVIEW block diagram. Exposing the global .PARAM for the Multisim schematic (circuit diagram) may allow users to change a parameter value when running Multisim silently (passively), which may be very useful for parameter sweep analysis, and may further provide the ability to change the .PARAM value during simulation.

In another embodiment, support for vector type LabVIEW terminals may be provided, which may allow users to export Multisim buses directly to LabVIEW through the interface, rather than having to split the bus up into individual scalar elements.

Thus, more generally, support for respective parameters of the constituent simulations in the co-simulation may be provided to and from the other simulations in the co-simulation.

### Exemplary Co-Simulation Communication Interface

There are a number of different ways communication between the two (or more) simulations may be implemented. In other words, any of various communication interfaces may be used to communicate between the constituent simulations in the co-simulation.

For example, in some embodiments, the communication mechanism used for the exemplary Multisim-LabVIEW co-simulation may be based on pipes, familiar to those of skill in the art. A pipe is one means (of which there are many) that is used to perform inter-process communication (communication between two programs running on the same computer or two programs running on different computers connected on a network). Traditionally two processes (e.g., computer programs) attach to a pipe and use this mechanism to exchange data. A named pipe is one of the standard methods for inter-process communication (IPC), in this case, between LabVIEW and Multisim. In one embodiment, the first pipe may be set up by the first simulator or simulation environment (e.g., LabVIEW) and then the second simulator or simulation environment (e.g., Multisim) may complete the communication link by creating the other pipe. Other examples of popular inter-process communication methods that may be used include, but are not limited to: unnamed pipes (or simply pipes), shared memory, sockets, files, message passing, among others.

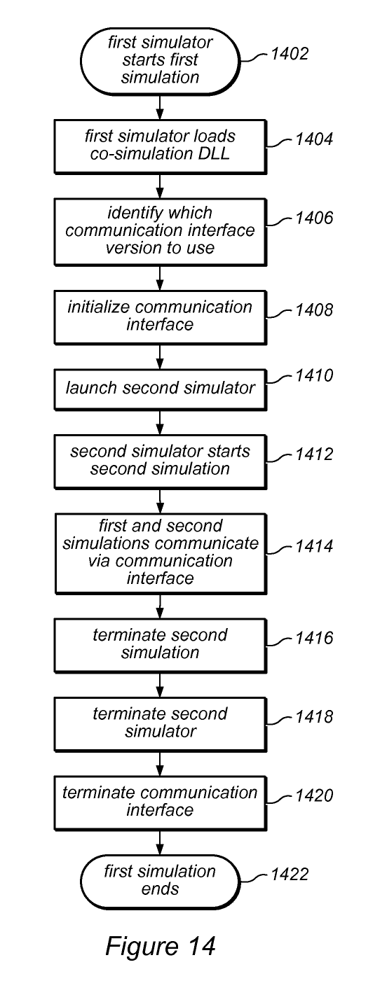

FIG. 14 is a flowchart of an exemplary method for establishing communications between simulators via a communication interface, whereby data may be passed between the two simulators (processes), and thus, between simulations. FIG. 14 illustrates one exemplary sequence of actions performed during the co-simulation process. Note that in the embodiment shown, information is sent between the two processes/simulations in the form of messages, which, if needed (depending on their size), may be further broken down into packets. It should be noted that the method of FIG. 14 is exemplary only, and that in various embodiments, some of the method elements shown may be performed concurrently, in a different order than shown, or may be omitted. Additional method elements may also be performed as desired. As shown, this method may operate as follows.

In 1402, a first simulator (e.g., LabVIEW) starts a first simulation (e.g., a LabVIEW simulation), e.g., in response to user input, or programmatically. For example, in one embodiment, the first simulator (or simulation environment, e.g., LabVIEW) may provide a graphical user interface (GUI) whereby the co-simulation may be started (and/or configured), e.g., in response to user input.

In 1404, the first simulator (e.g., LabVIEW) may load a co-simulation DLL. The co-simulation DLL may provide interface functionality whereby the two simulators can communicate, e.g., by providing a set of callable functions or tools, e.g., in a library. In one embodiment, the co-simulation DLL may be the interface of or for the first simulator. In other words, the co-simulation DLL may be part of, or associated with, the first simulator (e.g., LabVIEW).

In 1406, a determination may be made as to which communication interface version to use, i.e., a version of the communication interface to use may be identified. In other words, in some embodiments, multiple versions of the communication interface may be provided, and an appropriate version may be selected for the current execution, e.g., based on the version of the second simulator (e.g., Multisim). Note, however, that in other embodiments, a single version may be provided, and so this method element may be omitted.

In 1408, the communication interface may be initialized. In other words, the communication interface (of the selected version) may be instantiated and/or configured. For example, in one pipes-based implementation, communication pipes may be created and initialized. In one embodiment, the communication pipes may be created by the co-simulation DLL. The communication pipes may facilitate or implement communications between the first and second simulators.

In 1410, a second simulator (e.g., Multisim) may be started, e.g., launched. In one embodiment, the first simulator may start or launch the second simulator.

In 1412, the second simulator may start a second simulation (Multisim simulation).

In 1414, the first simulator and the second simulator may communicate via the communication interface initialized in 1408. In other words, the co-simulation may execute, including the first and second simulators executing their respective simulations, where the first and second simulators communicate with each other through the communication interface.

In 1416, the second simulation (e.g., Multisim simulation) may be terminated (ended).

In 1418, the second simulator may be terminated (ended).

In 1420, the communication interface initialized in 1408 may be terminated (e.g., stopped and deleted).

Finally, in 1422, the first simulation may end, e.g., may be terminated. Note that in some embodiments, the first simulator may also be terminated, although in other embodiments, the first simulator may remain running, and the user may initiate another co-simulation, e.g., with different simulations, configurations, etc.

Note that in the above method, the first simulator (e.g., LabVIEW) operates as a host or manager of the co-simulation process, e.g., starting/ending the co-simulation, loading the communication interface DLL, and providing a user interface whereby the user can interact with the co-simulation. However, in other embodiments, the second simulator, or even a third process, may operate as host/manager.

### Exemplary Interface Architectures

FIGS. 15A-15C illustrate various exemplary interface architectures for the co-simulation disclosed herein, according to some embodiments. Note that in each of the exemplary embodiments shown there are multiple second simulators, although, of course, in other embodiments, there may be only one second simulator.

FIG. 15A illustrates an interface architecture that accommodates multiple versions of the second simulator, and accordingly, multiple versions of a co-simulation library, e.g., co-simulation DLL, included in the communication interface, according to one embodiment. As may be seen, in this embodiment, the first simulator (e.g., a LabVIEW simulator) is coupled to a communication interface, e.g., with multiple co-simulation libraries (e.g., DLLs), which is itself coupled to multiple second simulators (e.g., Multisim simulators), and which provides for communication between the first and second simulators. Note that in the embodiment shown, there are multiple instances of version 1 of the second simulator, each communicating with the appropriate co-simulation library (v1) via unidirectional pipes, and a single instance of version 2 of the second simulator, which communicates with version 2 of the co-simulation library via some communication medium that may or may not differ from that used by the version 1 instances. This is simply to illustrate the notion that different versions of the simulators and/or interface (co-simulation library) may utilize different communication mechanisms, e.g., pipes, shared memory, etc., as desired.

FIG. 15B illustrates an embodiment where the second simulators each communicate with the communication interface (library), e.g., via unidirectional pipes, and where instances of the second (development and/or execution) environment communicate with the communication interface (library) via separate means. In other words, the simulators and their respective environments may communicate with the communication interface via separate and distinct channels or other communication mechanisms.

FIG. 15C illustrates an embodiment where the second simulators each communicate with the communication interface (library) through instances of the second (development and/or execution) environment. In other words, the simulators and their respective environments may communicate with the communication interface via the same channels or other communication mechanisms, and in this particular embodiment, through the (instances of) the second environment.

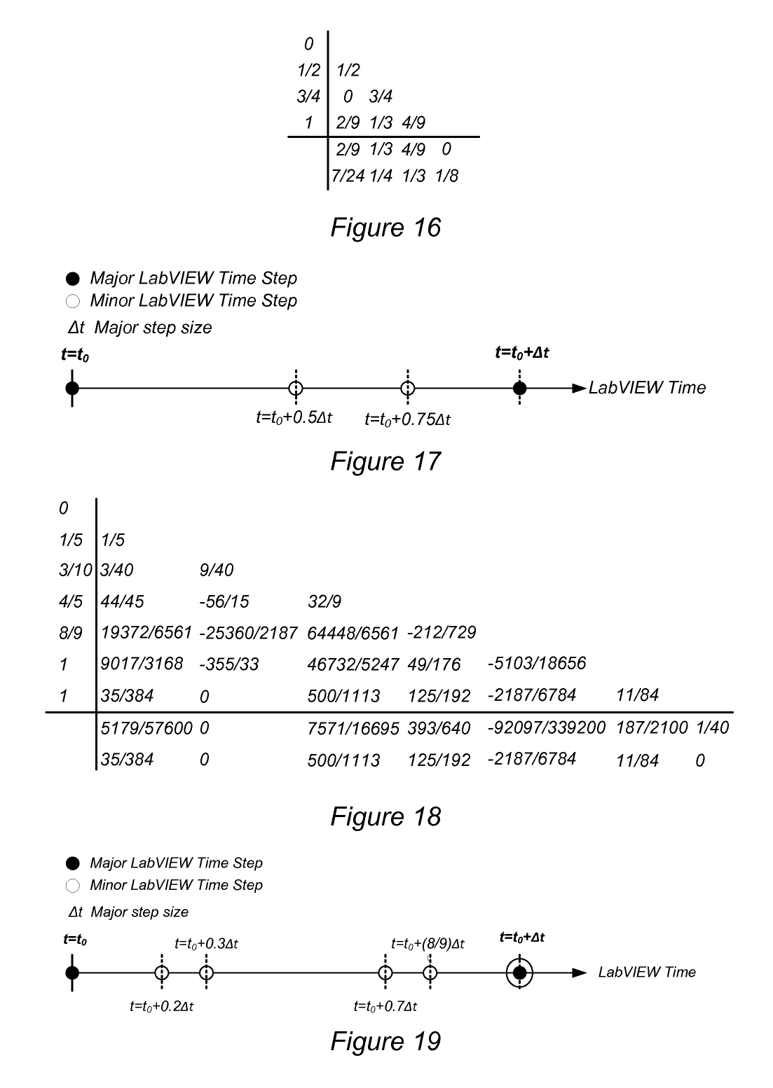

### FIGS. 16-19—Solvers

FIGS. 16-19 illustrate the use of various solvers, according to one embodiment. LabVIEW supports at least 5 different variable step-size ODE (ordinary differential equations) solvers. They can be classified according to the following:

Step-size: The step size is variable. Similar to Multisim, the variable step-size solvers specify a minimum and a maximum step-size. Note that for variable step-size solvers the step-size is changed based on the estimated error (like Multisim).

Implicit/Explicit: A solver is explicit if the output at the current time point is calculated only from previously calculated states. For an implicit solver, the results at the current time point, depends on the previously calculated states, as well as the current state. Multisim is an implicit solver.

Number of Steps: Single-step solvers approximate the behavior of a model at time t+Δt, by taking into account only the behavior of the model between times t and t+Δt. Conversely, multi-step solvers approximate the behavior at the model by taking into account the behavior at a number of previous time steps.

Table 1 lists the variable step-size ODE solvers that are currently supported by the LabVIEW control design and simulation module, although it should be noted that other solvers may be used in various other embodiments.

TABLE 1
ODE solvers supported by LabVIEW

Classification

| | | | Number of |
|---|---|---|---|
| ODE Solver | Implicit/Explicit | Step-size | Steps |
| Runge-Kutta 23 | Explicit | Variable | Single |
| Runge-Kutta 45 | Explicit | Variable | Single |
| BDF (Gear) | Implicit | Variable | Multi |
| Adams-Moulton | Semi-Implicit | Variable | Multi |
| Rosenbrock | Explicit | Variable | Single |

Below are descriptions of the use of some of the above solvers, and corresponding time points (or steps) evaluated via each solver.

### Runge-Kutta 23

Runge-Kutta 23 (RK23) is a variable step-size, single-step, explicit solver of the third order. The Bucher tableau (Bogacki-Shempine) for this method is shown in FIG. 16, from which it can be seen that this solver has two minor time steps, as illustrated in FIG. 17. Thus, using this solver entails third order, Runge-Kutta 23 (variable step-size) minor and major time steps.

### Runge-Kutta 45

Runge-Kutta 45 (RK45) is a variable step-size, single-step, explicit solver of the fifth order. The Bucher tableau (Dormand-Prince) for this method is shown in FIG. 18, from which it can be seen that this solver has 5 minor steps, where the last minor time step coincides with the time of the major time step, as illustrated in FIG. 19. Thus, using this solver entails fifth order, Runge-Kutta 45 (variable step-size) minor and major time steps.

### Multisim Simulators

Unlike LabVIEW solvers, typical SPICE simulators (like Multisim) use only a variable step-size solver. Because fixed step-size solvers do not perform well for SPICE simulation, all modern (prior art) SPICE simulators only support the variable time solver. The time stepping algorithm that is used by Multisim is the Local Truncation Error (LTE) algorithm, which operates as follows:

1. The LTE algorithm estimates the magnitude of the error computed at each time step. Based on this estimated error the step-size is adjusted: as the error increases the step-size is decreased, and as the error goes down the step-size is increased.

2. In addition to the LTE, if for whatever reason convergence is not successful after a preset number of iterations Multisim reduces the step-size by a factor of ⅛.

3. When convergence is successful, the step-size is increased by a factor of 2 (the maximum increase possible after any successful time step). Over several time steps the step-size can be increased in this manner until it reaches the maximum allowed time step (TMAX).

### Breakpoints

Like virtually all SPICE simulators, Multisim has the concept of a breakpoint. A breakpoint is simply a special time point, at which a known signal is about to perform an abrupt transition from one state to another. Breakpoints are encountered with most input sources, particularly the piecewise linear sources. During simulation, a time-step is evaluated at each known breakpoint (or extremely close to it). Once a break point is hit, the step-size for the next time step may be cut by a factor of 10, and the integration method changed to Forward Euler (only for the next time point).

Because of the lock-step step-size negotiation described herein, LabVIEW may also see the Multisim breakpoints.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A non-transitory computer accessible memory medium that stores program instructions executable by a processor to implement:
a co-simulation program, comprising:
a first simulator; and
a second simulator;
wherein execution of the co-simulation program comprises executing the first simulator and the second simulator, during which the first simulator receives input from the second simulator and provides output to the second simulator, and the second simulator receives input from the first simulator and provides output to the first simulator; and
wherein during execution, the first simulator and the second simulator negotiate step-size as peers to dynamically synchronize the first simulator and the second simulator.

2. The non-transitory computer accessible memory medium of claim 1,
wherein the co-simulation program further comprises a communication interface for communication between the first simulator and the second simulator; and
wherein analog signals or data are communicated between the first simulator and the second simulator directly via the communication interface without requiring any bridge elements in the communication interface to perform value translations of the analog signals or data.

3. The non-transitory computer accessible memory medium of claim 2,
wherein the communication interface comprises a bridge element for translating values of digital signals or data
wherein digital signals or data are communicated between the first simulator and the second simulator via the communication interface using a bridge element in the communication interface to perform value translations of the digital signals or data.

4. The non-transitory computer accessible memory medium of claim 2,
wherein the second simulator executes in the co-simulation program passively, wherein during execution, errors and warnings from the second simulator are forwarded through the communication interface and presented via the first simulator.

5. The non-transitory computer accessible memory medium of claim 1,
wherein the a co-simulation program further comprises at least one third simulator;
wherein execution of the co-simulation program further comprises executing the at least one third simulator, during which the first simulator or the second simulator receives input from the at least one third simulator and provides output to the at least one third simulator, and the at least one third simulator receives input from the first simulator or the second simulator and provides output to the first simulator or the second simulator; and
wherein during execution, the first simulator, the second simulator, and the at least one third simulator negotiate step-size as peers to dynamically synchronize the first simulator, the second simulator, and the at least one third simulator.

6. The non-transitory computer accessible memory medium of claim 5,
wherein at least two of the first simulator, the second simulator, and the at least one third simulator are each directed to a different respective application domain.

7. The non-transitory computer accessible memory medium of claim 6,
wherein the different respective application domains comprise two or more of:
mechanical;
chemical;
electronic;
electrical;
hydrodynamic;
thermodynamic; or
control.

8. The non-transitory computer accessible memory medium of claim 5,
wherein the second simulator, and the at least one third simulator are each directed to a different electronic circuit.

9. The non-transitory computer accessible memory medium of claim 5,
wherein the second simulator, and the at least one third simulator are each directed to a different model in the same application domain.

10. The non-transitory computer accessible memory medium of claim 5, wherein the first simulator, the second simulator, and the at least one third simulator can each reject a step-size for the co-simulation, in response to which the first simulator, the second simulator, and the at least one third simulator renegotiate a step-size for the co-simulation.

11. The non-transitory computer accessible memory medium of claim 5,
wherein the first simulator and the second simulator utilize variable step-size solvers.

12. The non-transitory computer accessible memory medium of claim 1,
wherein the first simulator and the second simulator are each directed to a different respective application domain.

13. The non-transitory computer accessible memory medium of claim 12,
wherein the different respective application domains comprise two or more of:
mechanical;
chemical;
electronic;
electrical;
hydrodynamic;
thermodynamic; or
control.

14. The non-transitory computer accessible memory medium of claim 1, wherein the first simulator and the second simulator can each reject a step-size for the co-simulation, in response to which the first simulator and the second simulator renegotiate a step-size for the co-simulation.

15. The non-transitory computer accessible memory medium of claim 1,
wherein at least one of the first simulator or the second simulator is configured to provide one or more initial values to the other of the first simulator or the second simulation, and wherein the other of the first simulator or the second simulator is configured to determine at least one of its initial values based on the provided one or more initial values.

16. The non-transitory computer accessible memory medium of claim 1,
wherein the first simulator and the second simulator utilize variable step-size solvers.

17. A computer-implemented method for synchronizing simulations in a co-simulation program, the method comprising:
utilizing a computer to perform:
including a first simulator and a second simulator in a co-simulation program;
executing the co-simulation program, including executing the first simulator and the second simulator, wherein during execution, the first simulator receives input from the second simulator and provides output to the second simulator, and the second simulator receives input from the first simulator and provides output to the first simulator, wherein said executing the co-simulation program comprises:
the first simulator and the second simulator negotiating step-size as peers to dynamically synchronize the first simulator and the second simulator.

18. The computer-implemented method of claim 17,
wherein the co-simulation program further comprises a communication interface for communication between the first simulator and the second simulator; and
wherein analog signals or data are communicated between the first simulator and the second simulator directly via the communication interface without requiring any bridge elements in the communication interface to perform value translations of the analog signals or data.

19. The computer-implemented method of claim 18,
wherein the second simulator executes in the co-simulation program passively, wherein during execution, errors and warnings from the second simulator are forwarded through the communication interface and presented via the first simulator.

20. The computer-implemented method of claim 17,
wherein the first simulator and the second simulator are each directed to a different respective application domain.

21. The computer-implemented method of claim 20, wherein the different respective application domains comprise two or more of:
mechanical;
chemical;
electronic;
electrical;
hydrodynamic;
thermodynamic; or
control.

22. The computer-implemented method of claim 17, further comprising:
utilizing the computer to perform:
the first simulator or the second simulator rejecting a step-size for the co-simulation; and
the first simulator and the second simulator renegotiating a step-size for the co-simulation in response to said rejecting.
